(19) United States
(12) Patent Application Publication
(10) Pub. No.: US 2003/0120503 A1
(43) Pub. Date: Jun. 26, 2003

(54) Method, system and computer product for electronic document and records management

(76) Inventors: Dorothy Davidson, Washington, DC (US); Carl J. Elsishans, Glastonbury, CT (US); Heather L. Morgan, Firestone, CO (US); Kelly A. Germolus, Loveland, CO (US); David Eric Joseffy, Lakewood, CO (US)

Correspondence Address: CANTOR COLBURN, LLP, 55 GRIFFIN ROAD SOUTH, BLOOMFIELD, CT, 06002

(21) Appl. No.: 10/270,099

(22) Filed: Oct. 11, 2002

Related U.S. Application Data
(60) Provisional application No. 60/328,915, filed on Oct. 12, 2001.

(51) Int. Cl. G06F 17/60

(52) U.S. Cl. 705/1

(57) ABSTRACT

A method for automated electronic document and records management. The method also verifies that the operator meets training requirements associated with the specific role for that characterization process. A characterization process is selected for the waste container using a qualified system. Qualification of the system is performed automatically by the method and includes verifying that the system: uses only quality parts that were purchased in compliance with an approved quality assurance program; uses measurement and test equipment that is properly calibrated; and is approved by the site project manager. Prior to starting the characterization, the method verifies that the system successfully completed the measurement control check. The performance of the characterization process is initiated in response to the characterization system meeting the measurement control standard. Output from the characterization process includes characterization data. After characterization data are input, the method automatically creates all report forms required to certify the waste for disposal. These forms include checklists that are linked automatically to the characterization data stored for each waste container. Next, a verification that the characterization data passes a generation level data review is performed. A verification that the characterization data passes a project level review is performed in response to the characterization data passing the generation level data review. After final approval by the site project manager, the characterization data are transmitted to a receiving system in response to the characterization data passing the project level data review.

### CROSS REFERENCE TO RELATED APPLICATIONS

This application claims the benefit of U.S. Provisional Patent Application No. 60/328,915 filed on Oct. 12, 2001, the entire contents of which are incorporated herein by reference.

### BACKGROUND OF INVENTION

The present disclosure relates generally to a method for electronic document and records management. In particular, the present disclosure is a method for electronic document and records management for documents and records associated with transuranic waste materials including automated data review and reporting for certification.

The management of transuranic waste materials, including radioactive and mixed (radioactive and hazardous) waste, is important to maintaining the environment. Hazardous or radioactive waste can be defined as any material that contains or is contaminated by hazardous contaminants or radionuclides at concentrations or radioactivity levels greater than a particular level set by the government. These levels set by the government are based on a determination of what constitutes an unacceptable level of risk to personnel or the environment. In addition, transuranic waste is material containing radionuclides greater in atomic number than uranium with half-lives greater than twenty years that has no foreseen future usefulness. Waste disposal refers to placing the transuranic waste in approved radioactive waste containers at a disposal site such as the Waste Isolation Pilot Plant (WIPP) in Carlsbad, N. Mex., without the intention of retrieval. Making sure that the waste containers are secure, and that their storage and maintenance is properly managed raises special concerns because transuranic waste materials retain radioactivity for thousands of years.

Managing the documents and records associated with storing transuranic waste can be a logistical nightmare. For example, waste containers, designated for storage at WIPP, originate at different locations throughout the United States (U.S.). Coordinating the large volumes of data associated with the waste and its transportation for regulatory compliance review and reporting is an ever-increasing challenge. Current techniques include numerous manual steps, which are prone to human error. Furthermore, manual steps are slow and cumbersome, which makes it costly and difficult to accurately manage the documents and records in a timely fashion. Thus, using current techniques for data review and reporting to demonstrate regulatory compliance can be expensive and not always comprehensive, accurate or timely.

### SUMMARY OF INVENTION

One aspect of the invention is a method for automated electronic document and records management. The method comprises receiving a request from an operator for characterization of a waste container. The method also verifies that the operator meets training requirements associated with the specific role for that characterization process. A characterization process is selected for the waste container using a qualified system. Qualification of the system is performed automatically by the method and includes verifying that the system: uses only quality parts that were purchased in compliance with an approved quality assurance program; uses measurement and test equipment that is properly calibrated; and is approved by the site project manager. Prior to starting the characterization, the method verifies that the system successfully completed the measurement control check. The performance of the characterization process is initiated in response to the characterization system meeting the measurement control standard. Output from the characterization process includes characterization data. After data are input the method automatically creates all report forms required to certify the waste for disposal. These forms include checklists that are linked automatically to the characterization data stored for each waste container. Next, verification that the characterization data passes a generation level data review is performed. Verification that the characterization data passes a project level review is performed in response to the characterization data passing the generation level data review. After final approval by the Site Project Manager, the characterization data are transmitted to a receiving system in response to the characterization data passing the project level data review.

Another aspect of the invention is a system for automated electronic document and records management. The system comprises a network, a storage device in communication with the network and a user system in communication with the network. The system also comprises a host system in communication with the network. The host system includes electronic document and records management software to implement a method.

Another aspect of the invention is a computer product for electronic document and records management. Further aspects of the invention are disclosed herein. The above discussed and other features and advantages of the invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is a block diagram of an exemplary system for electronic document and records management;

FIG. 2 is a flowchart of an exemplary process for electronic document and records management;

FIG. 3 is an exemplary process for electronic document and records management for non-destructive examination (NDE);

FIG. 4 is an exemplary process for electronic document and records management for non-destructive assay (NDA);

FIG. 5 is an exemplary process for electronic document and records management for headspace gas (HSG) analysis;

FIG. 6 is an exemplary process for electronic document and records management for visual examination (VE);

FIG. 7 is an exemplary process for container routing;

FIG. 8 depicts an exemplary routing form for waste containers;

FIG. 9 depicts an exemplary generation level data review checklist with automatic links for verification;

FIG. 10 is a diagram showing various components linked to the certification process;

FIG. 11 depicts an exemplary system qualification template;

FIG. 12 depicts an exemplary document control template;

FIG. 13 depicts an exemplary quality process; and

FIG. 14 depicts an exemplary administration process.

### DETAILED DESCRIPTION OF THE INVENTION

An embodiment of the present invention for electronic document and records management standardizes reporting to provide consistency for transuranic (TRU) waste characterization and reporting via the Internet. Exemplary reports describe the constituents of the TRU waste as specified in the government regulations. For TRU waste that is destined for disposal at the Waste Isolation Pilot Plant (WIPP) in Carlsbad, N. Mex., the reports can include: results of characterization data from non-destructive examination (NDE) such as real-time radiography or computerized tomography/digital radiography; non-destructive assay (NDA) for the radioactive content; and headspace gas (HSG) analysis for the volatile/semivolatile organic and flammable compounds. By automating the reporting process, the present invention (also referred to as “e-QA”) can be used to reduce the number of people and amount of elapsed time it takes to create the reports. In addition, the quality of the data can be improved by minimizing human error and ensuring that only qualified personnel and characterization systems are used to characterize the waste while maintaining compliance with regulatory requirements. The electronic system also allows integration of remote users via the Internet to take advantage of technical expertise throughout the DOE complex and to accelerate the approval process for compliance. The access to electronic quality records provides complex-wide transparency to the characterization processes, increasing confidence in data quality for TRU waste disposal at WIPP.

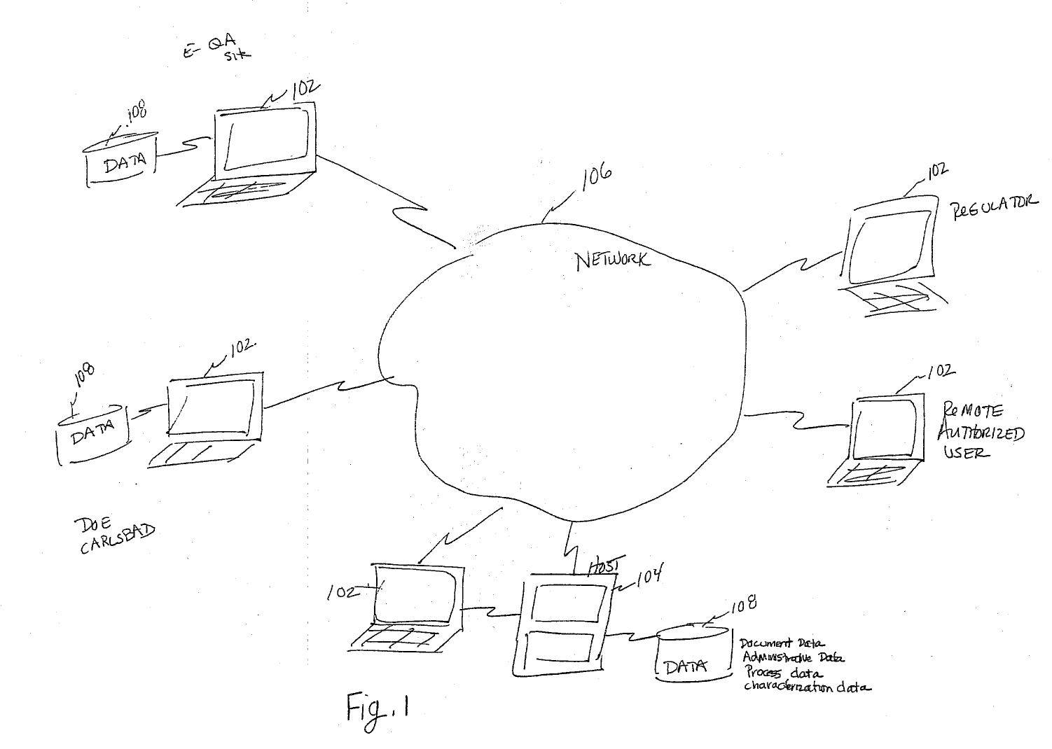

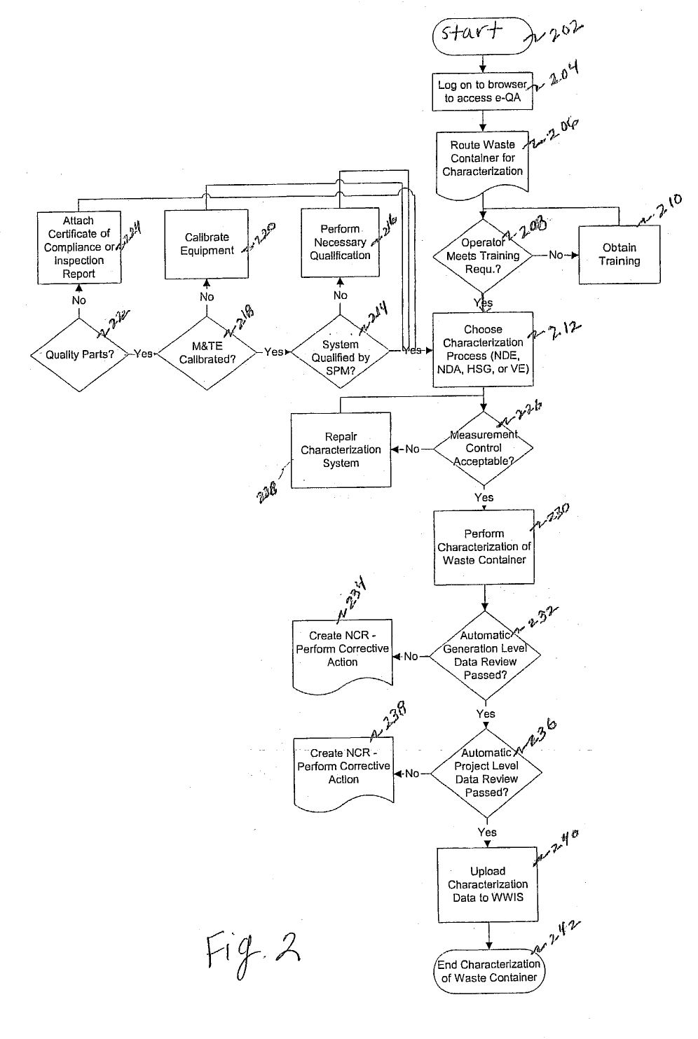

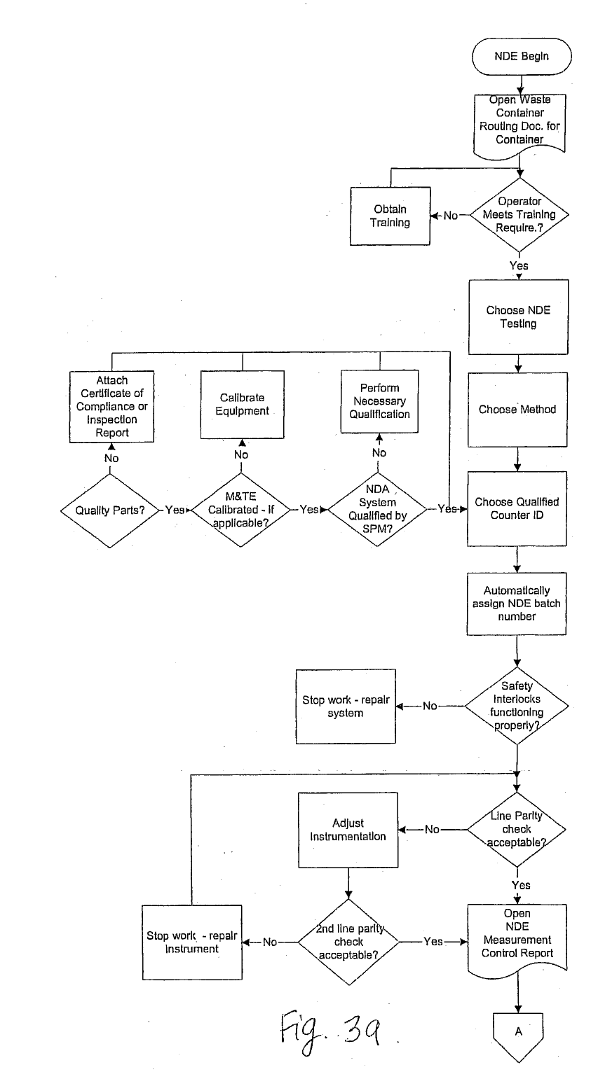

FIG. 1 is a block diagram of an exemplary system for electronic document and records management. The system of FIG. 1 includes one or more user systems 102 through which users at one or more locations can contact a host system 104. In a preferred embodiment, the host system 104 executes a program that performs document and records management. The user systems 102 may be coupled to the host system 104 via one or more networks 106. Each user system 102 may be implemented using a general-purpose computer executing a computer program for carrying out the processes described herein. The user systems 102 may be personal computers or host attached terminals. If the user systems 102 are personal computers, the processing described herein may be shared by a user system 102 and the host system 104 by providing an applet to the user system 102.

The network 106 may be any type of known network including a local area network (LAN), a wide area network (WAN), and a global network (e.g., Internet). The user system 102 may be coupled to the host system 104 through multiple networks (e.g., intranet and Internet) so that not all user systems 102 are coupled to the host system 104 through the same network. For example, the network 106 may include a virtual private network (VPN) and the Internet. The VPN may use encryption and/or tunneling to connect users to the host system 104. One or more of the user systems 102 and the host system 104 may be connected to the network 106 in a wireless fashion and the network 106 may be a wireless network. In an exemplary embodiment, the network 106 includes both the Internet and a VPN, and each user system 102 executes a user interface application (e.g., web browser) to contact the host system 104 through the network 106.

FIG. 1 also depicts the sources of data for electronic document and records management in an exemplary embodiment of present the invention. The data may be sourced or stored on a plurality of user systems 102 across the network 106 or the data may be located on a storage device 108 attached to the host system 104. For example, data can include characterization data such as identification and source for a particular container of TRU waste. Other data may include assay data, which contains the assay results or measurement data taken by a counter for a particular waste container. Additional data, such as regulatory data, may include specifications set by the government.

An exemplary embodiment of the present invention includes four main electronic document and records management databases: a document database, an administrative database, a process database and a characterization database. The document database includes procedures, plans and ancillary documents. The administrative database contains forms required for administrative activities such as training and quality assurance, and the forms can be indexed by form name and sorted by the fields in the forms. The process database includes the forms used for the actual waste characterization process and can be indexed by waste container identification numbers. The characterization data includes the actual data generated in the characterization process. Note that the electronic document and records management data may be gathered from locations around the world and then consolidated into a single database stored on the storage device 108 connected to the host system 104. Alternatively, data may be obtained from one or more remote locations on a real-time basis, wherein the user may access the data via a browser interface. The storage device 108 may be implemented using a variety of devices for storing electronic information such as a file transfer protocol (FTP) server. It is understood that the storage device 108 may be implemented using memory contained in a host system 104 or a user system 104 or it may be a separate physical device.

The host system 104 may be implemented using one or more servers operating in response to a computer program stored in a storage medium accessible by the server. For example, in one embodiment, the host system 104 may include one or more primary servers and secondary servers. The primary servers may be located at government facilities and other locations housing particular data or the like. The secondary servers may be located at facilities performing the electronic document and records management. The host system 104 may operate as a network server (often referred to as a web server) to communicate with the user systems 102. The host system 104 handles sending and receiving information to and from user systems 102 and can perform associated tasks.

The host system 104 may also include a firewall to prevent unauthorized access to the host system 104 and enforce any limitations on authorized access. For instance, an administrator may have access to some or all portions of the entire system, along with the authority to modify portions of the system. In contrast to the administrator, an analyst at a remote user system 102 may only have authority to read particular data records and fields. The firewall may be implemented using conventional hardware and/or software as is known in the art.

The host system 104 may also operate as an application server. The host system 104 executes one or more computer programs to perform electronic document and records management. Processing may be shared by the user system 102 and the host system 104 by providing an application (e.g., java applet) to the user system 102. Alternatively, the user system 102 can include a stand-alone software application for performing a portion of the processing described herein. As previously described, it is understood that separate servers may be used to implement the network server functions and the application server functions. Alternatively, the network server, the firewall, and the application server may be implemented by a single server executing computer programs to perform the requisite functions.

An exemplary embodiment of the present invention includes three sites A, B, and C; and includes the Internet and a VPN being combined to provide the network 106. Sites B and C are connected to the VPN network 106 and site A is connected to both the VPN and the Internet networks 106. Remote user systems 102 can access the host 104 at site A through the Internet and also the VPN, if they have the proper access authority, through site A. Through the VPN, a user system 102 can access sites B and C if they have the proper authority. In this exemplary embodiment, Lotus Notes, a commercially available software package, running in a Windows environment is utilized to provide mailing and document/database management services. The Domino TM Server portion of Lotus Notes is used to provide a shared database on the storage device 108 and mail routing. Notes Workstation is utilized to allow user systems 102 to communicate with the Domino TM Server. Data, such as forms, procedures, training, and quality assurance information are stored in the Lotus Notes database on the storage device 108. The characterization data is stored in a separate database on a storage device 108 connected to the host 104. In an exemplary embodiment, sites B and C include Domino TM Servers and data that is generated and stored by user systems 102. Sites B and C are connected to the VPN through a firewall. In an exemplary embodiment, Lotus Notes provides security through restricting data access based on user-id. In addition, Lotus Notes provides password security for access to the system and supports electronic signatures. In an exemplary embodiment, the storage device 108 containing the application data is backed up on a daily basis and an off-site copy of the data is maintained for data recovery purposes.

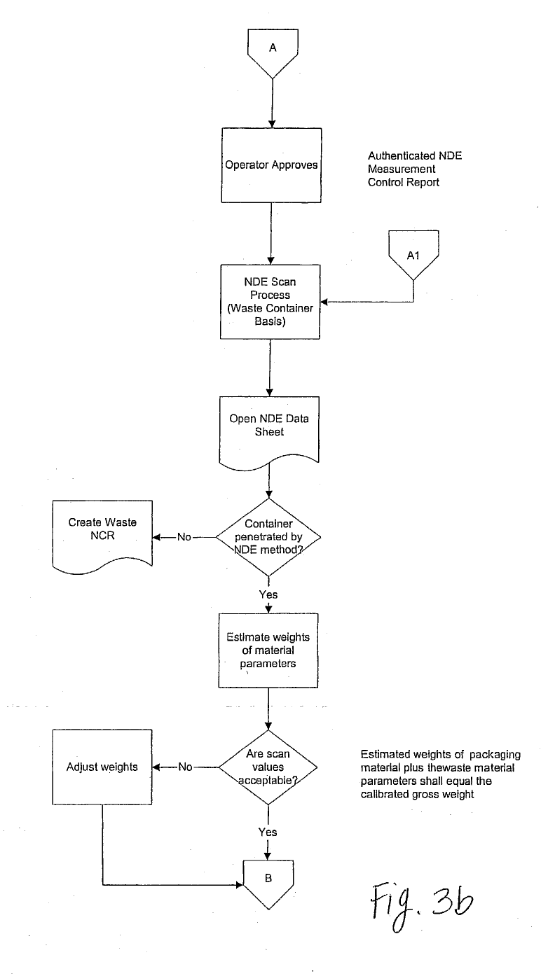

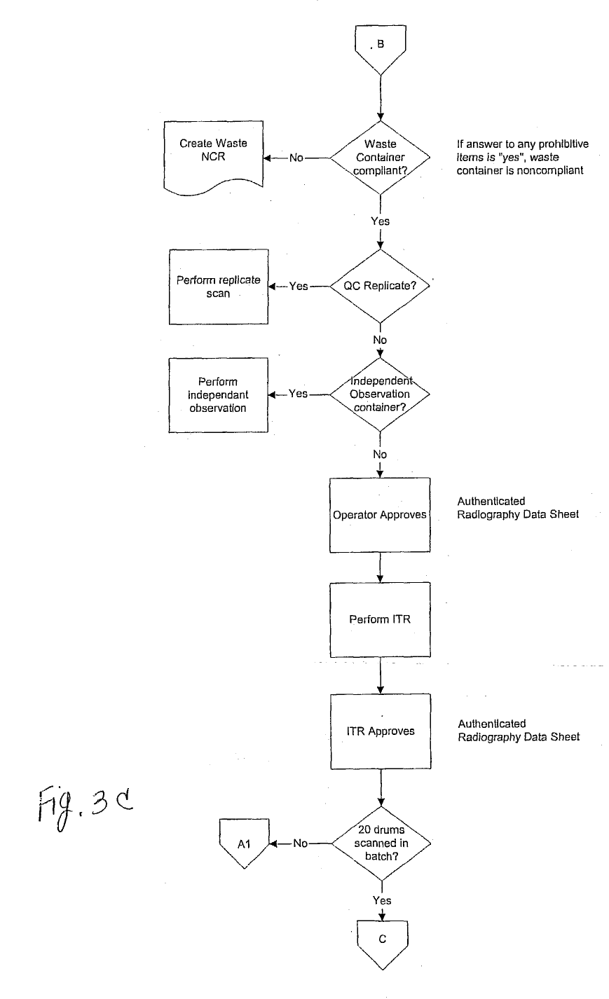

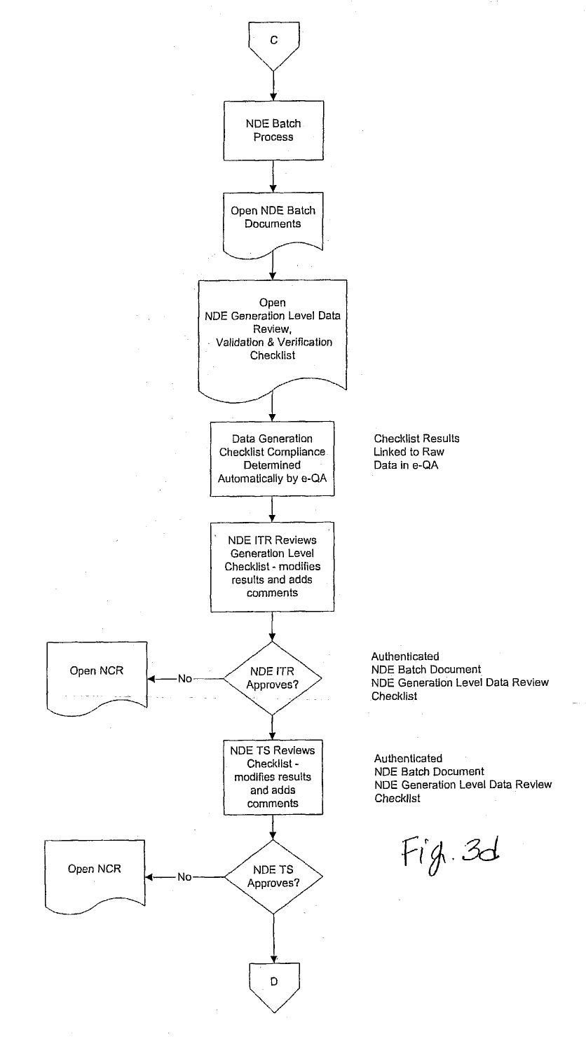

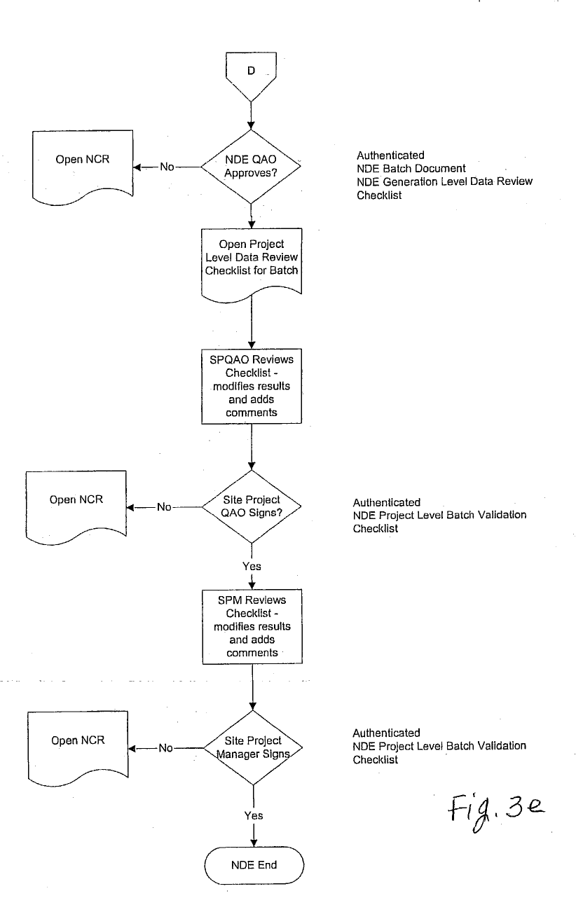

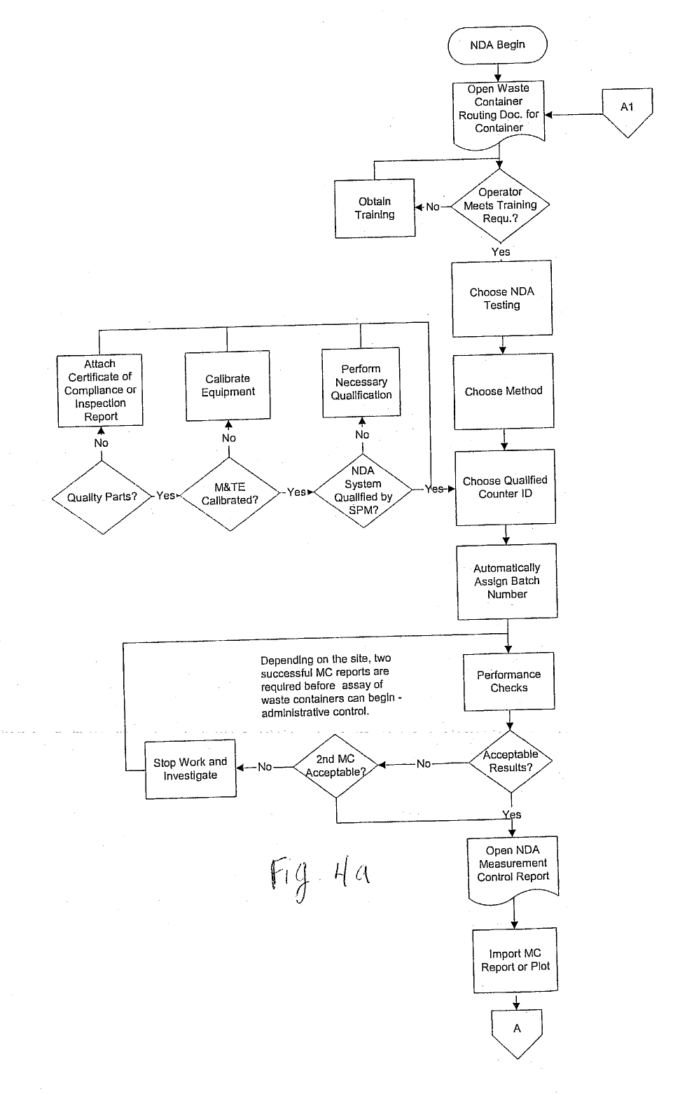

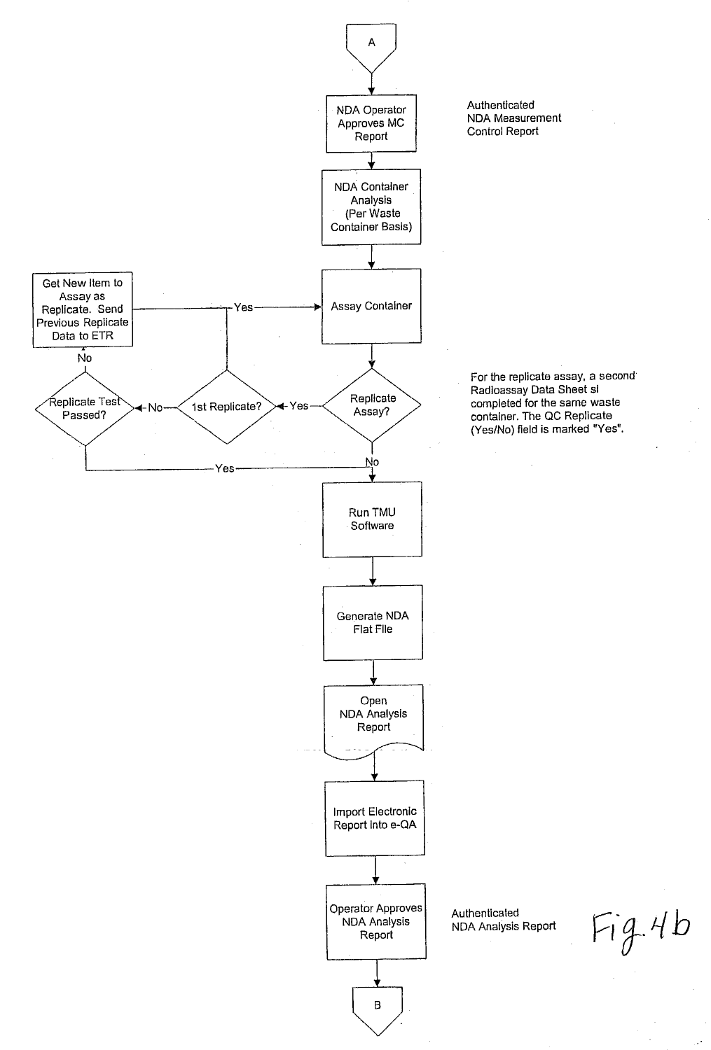

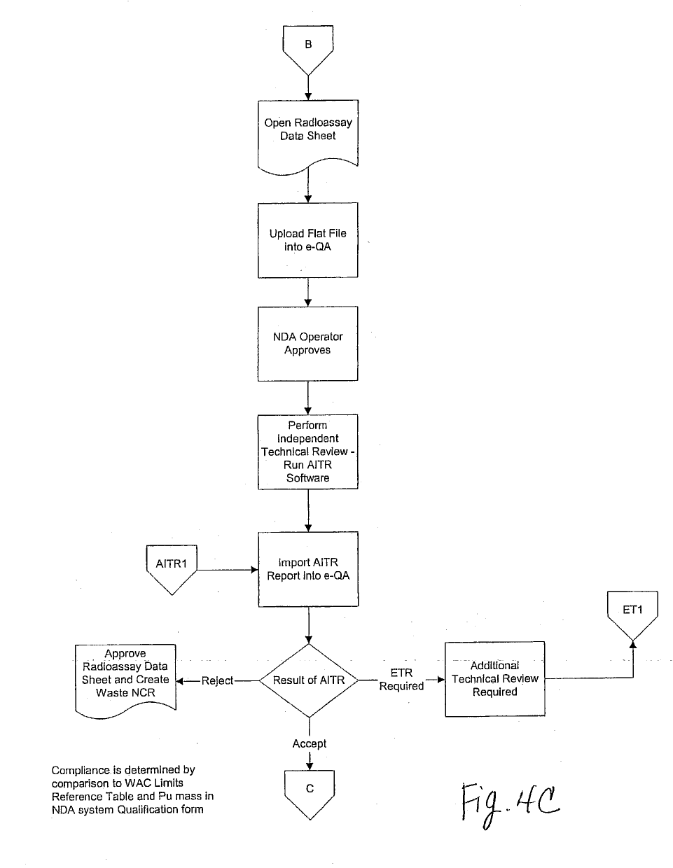

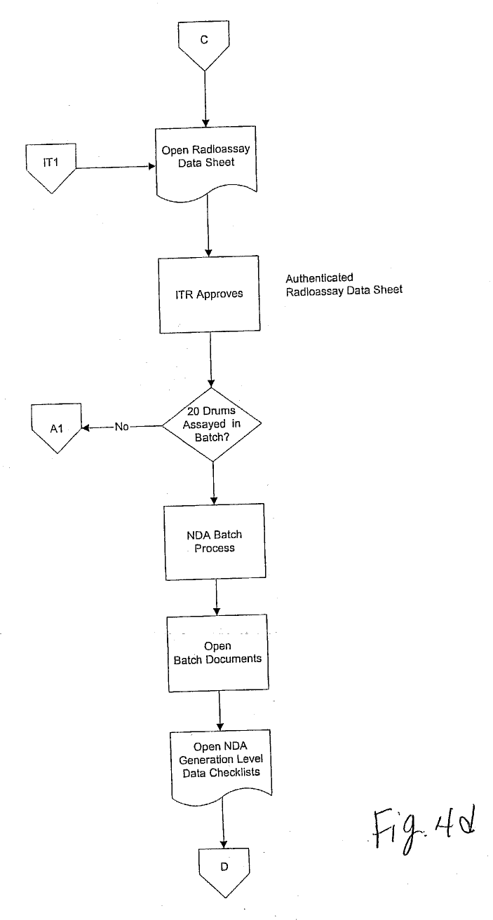

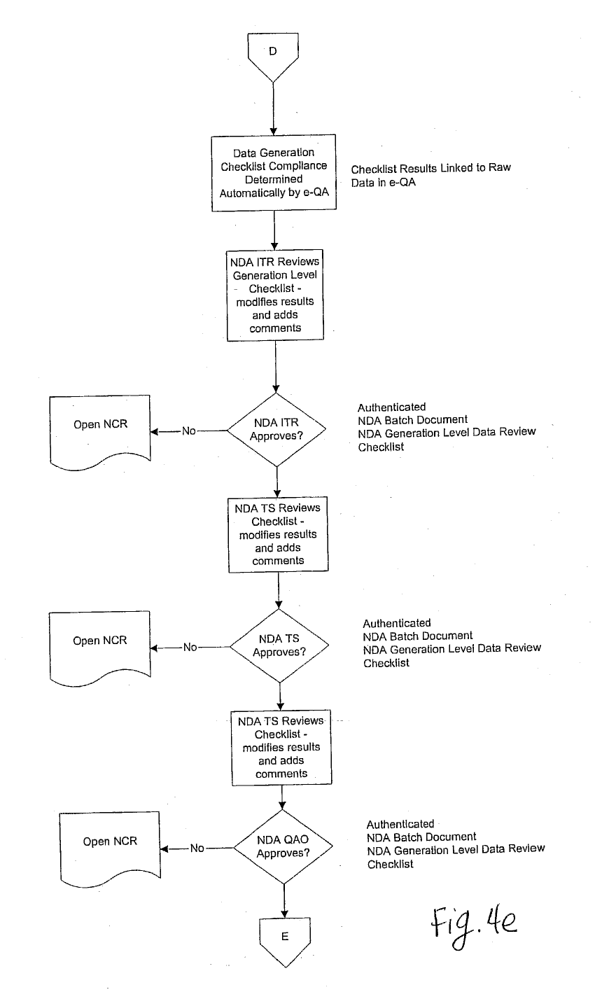

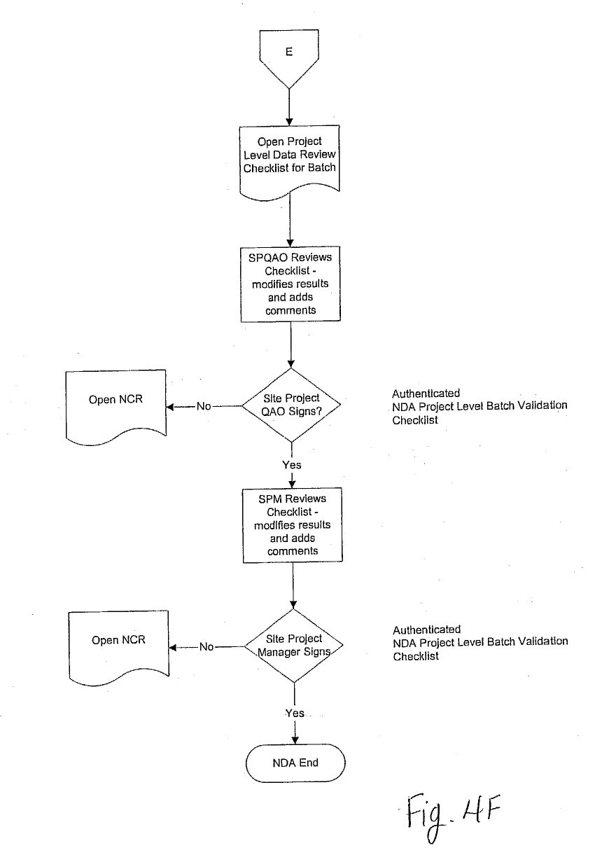

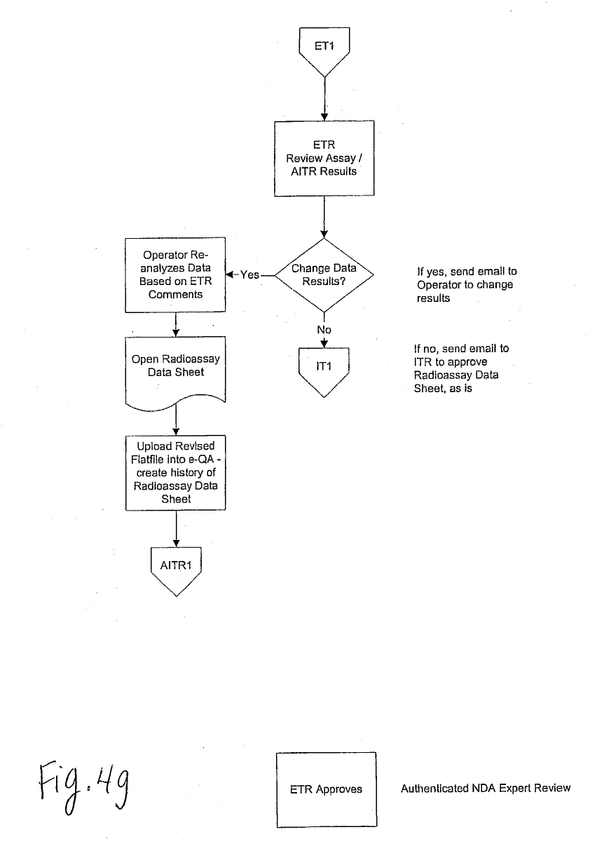

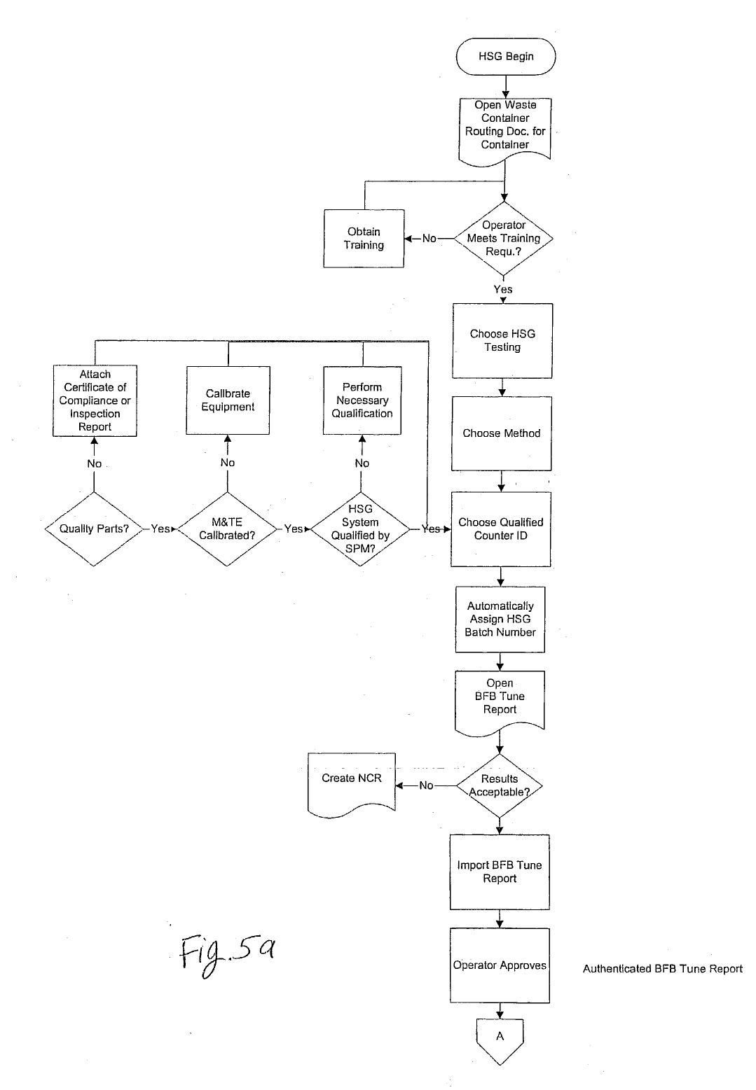

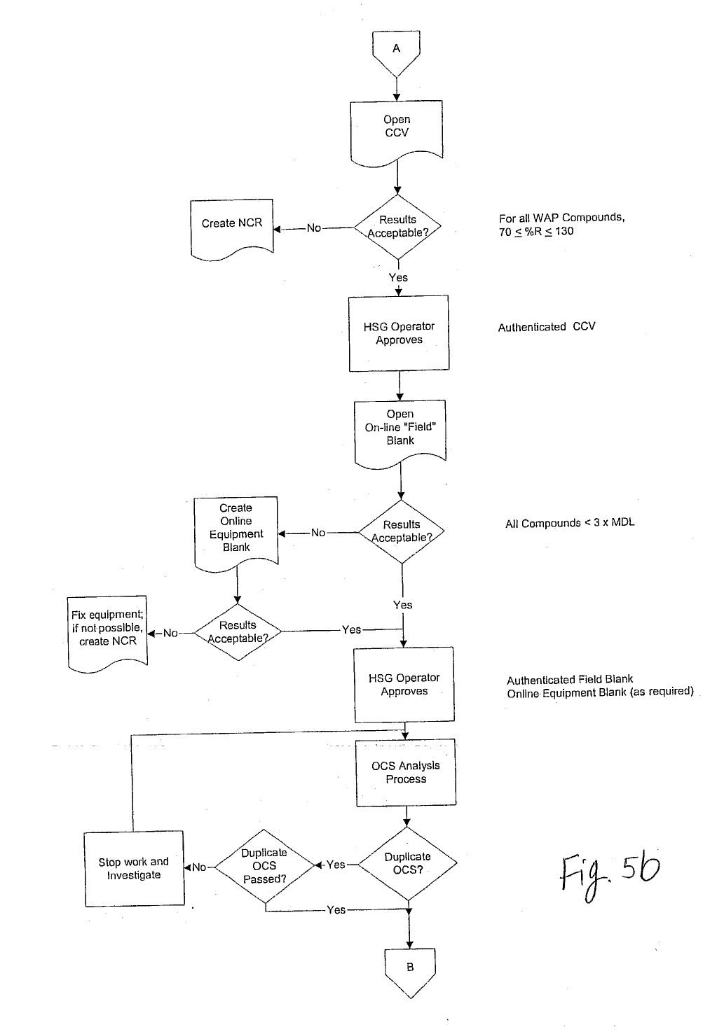

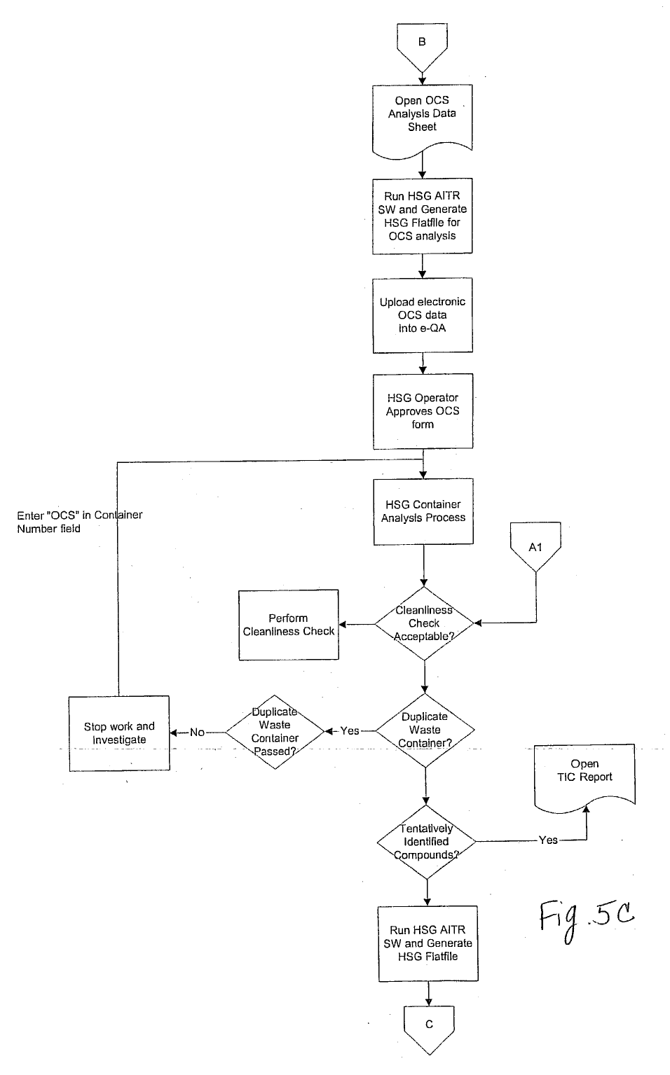

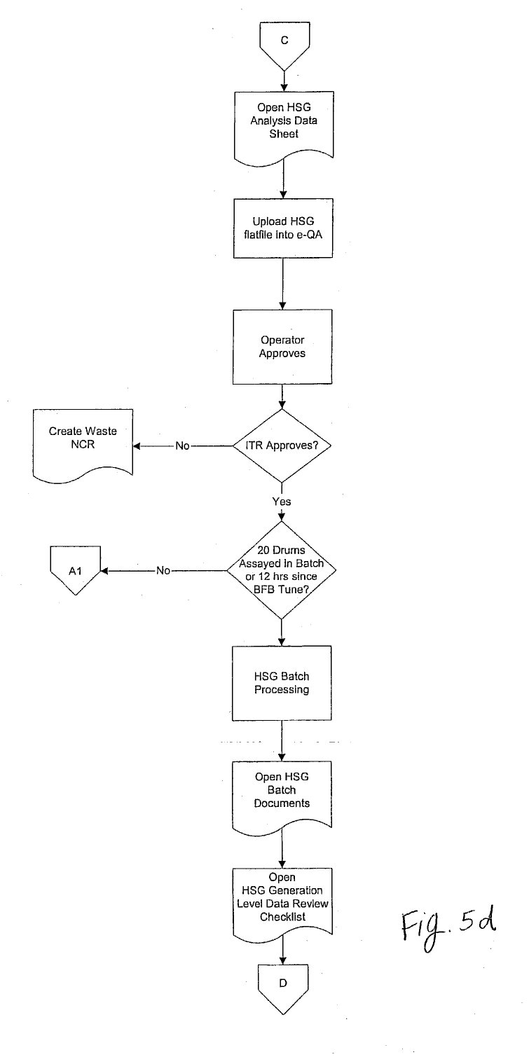

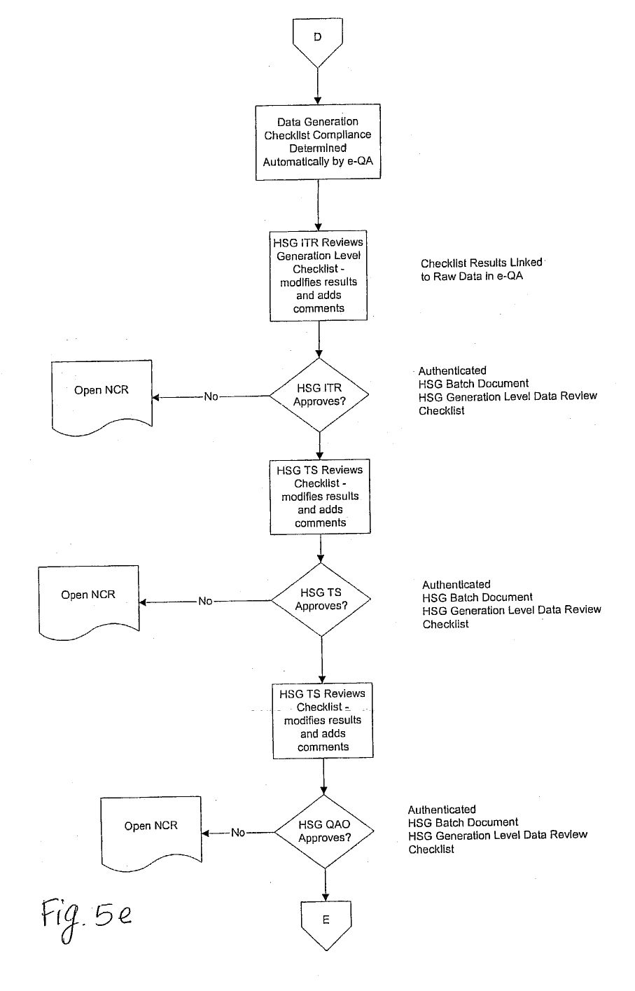

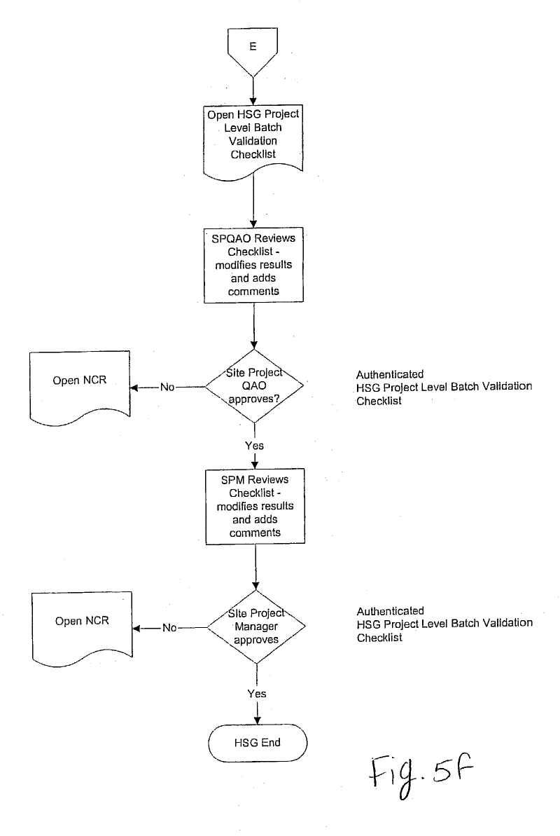

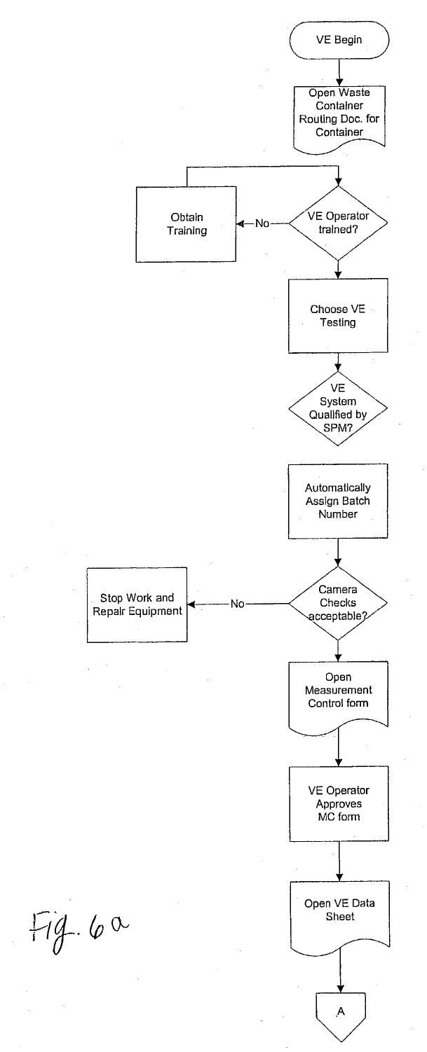

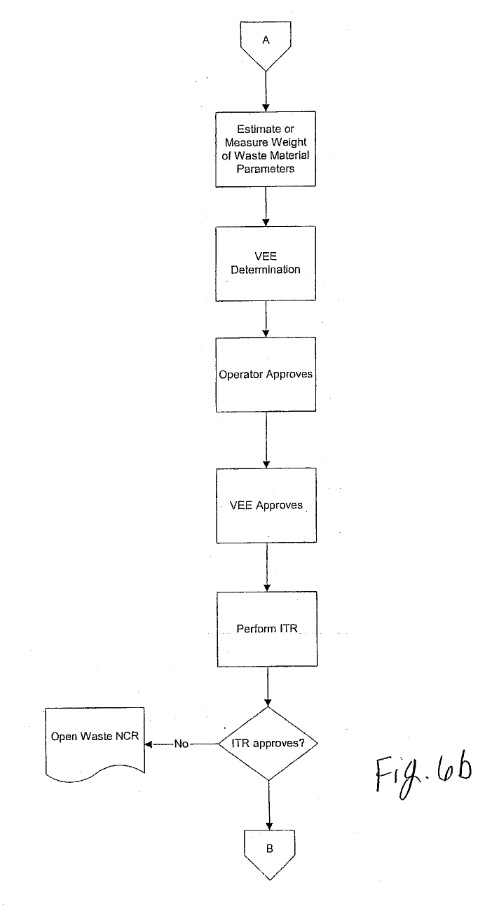

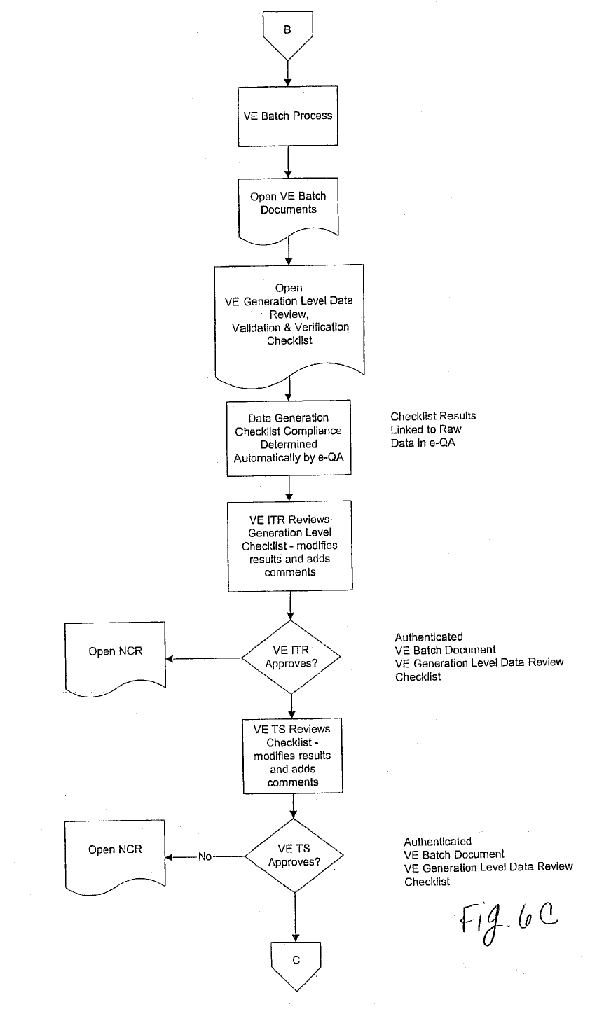

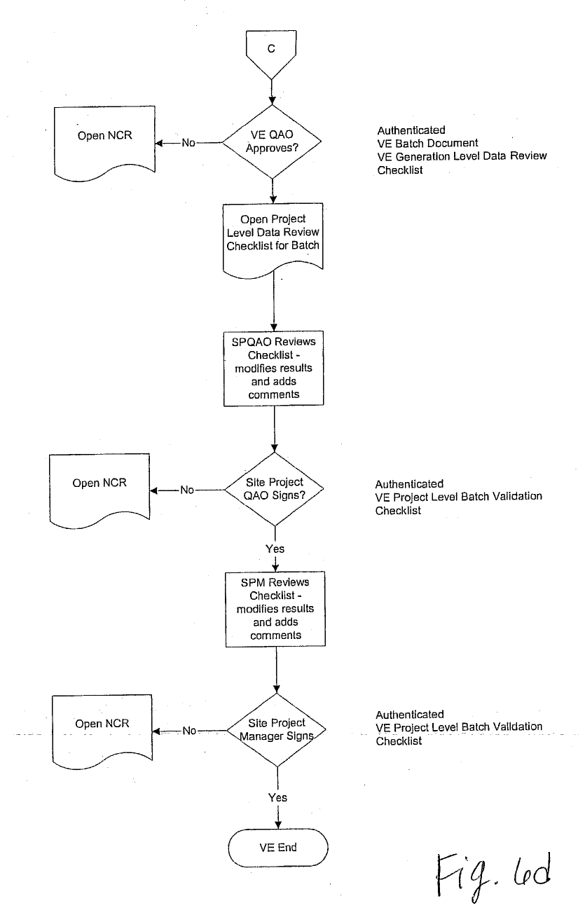

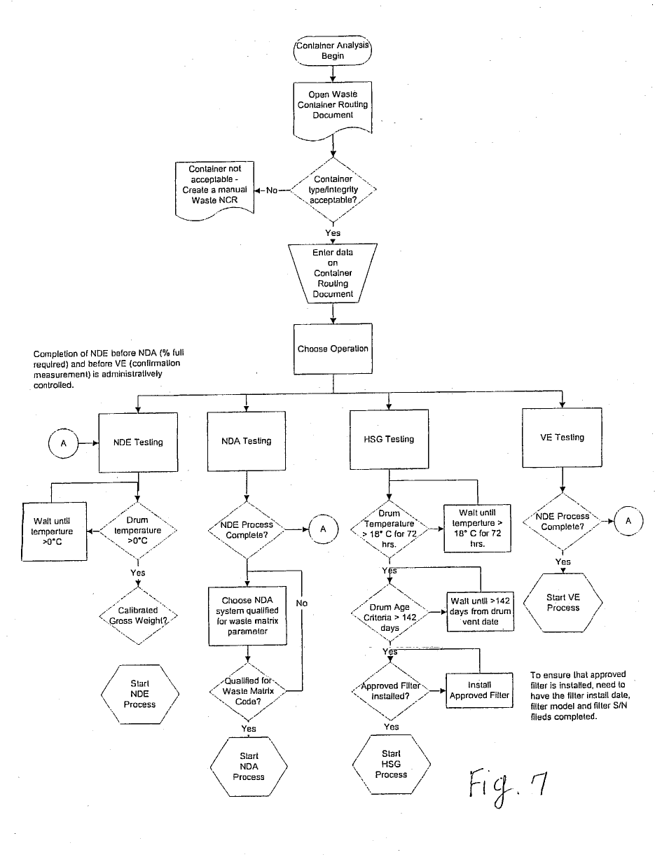

FIG. 2 is a flowchart of an exemplary high-level process for electronic document and records management. The process depicted in FIG. 2 is generalized and applies to a variety of characterization programs including NDE, NDA, HSG, and visual examination (VE). FIGS. 3-6 depict exemplary detailed sample process flows for each of these characterization programs that could be implemented using an embodiment of the present invention. In addition, FIG. 7 depicts a sample waste container routing process that could be implemented in an exemplary embodiment of the present invention. Referring to FIG. 2, an exemplary process for electronic document and records management will now be described. The process is entered at step 202 when a waste container to be characterized for disposal is identified by the DOE site. At step 204, the system operator logs on to the browser, or electronic document and records management system. At step 206 the waste container data that was routed by the DOE site is identified for characterization. The operator enters the TRU characterization program and enters all of the known information in the waste container routing document as depicted in FIG. 8, including data such as the container number, generator site, container type, gross and net weights, date the waste container was closed, vent date (if applicable), the hazardous waste code, the transuranic content (TRUCON) code, the surface dose rate, and the waste type code. At step 208, the system does a check to verify that the operator meets the training requirements (e.g., has the required reading for the procedures been completed). If the operator does not meet the training requirements, step 210 is performed and the operator must obtain training before continuing to step 212.

If the operator does meet the training requirements at step 208, the operator starts the characterization process at step 212. Characterization systems that are qualified by the site project manager (SPM), have calibrated measurement and test equipment (M&TE) and contain quality approved parts are certified to perform characterization. These checks are performed in advance of starting the characterization measurement to minimize rework. Only systems that have passed all three checks are deemed to be qualified and will be presented to the operator as systems to choose from to perform the characterization. Step 214 checks that the system is qualified by the SPM. If the system is not qualified, then step 216 triggers a notification to request the required qualification and then loops back to step 212. Step 218 checks to see if the M&TE is calibrated. If the M&TE is not calibrated, then step 220 triggers a notification to calibrate the equipment and then loops back to step 212. At step 222 a check is made to see if the parts are quality parts. If they are not quality parts then step 224 is performed and the system triggers a certificate of compliance or inspection report that is attached to the characterization. Processing then continues with step 212. Before waste containers are measured, the operator performs measurement control checks (e.g., comparing results to a standard), at step 226, to ensure that the equipment is operating correctly. If step 226 results in measurement controls that are not acceptable, then step 228 is performed to trigger a repair to the characterization system. Step 226 is then performed again to verify that the repair has resulted in an acceptable measurement control. Once the measurement controls are determined to be acceptable in step 226, step 230 is performed and the operator starts measurements of the waste container for the process selected (NDE, NDA, or HSG). In an exemplary embodiment, all three characterization processes must be completed for disposal at WIPP. In addition, a VE process could be selected. Government regulations require that a VE be performed for a certain percentage of waste containers. The VE is performed to verify the results of the NDE. Once the measurements in step 230 are complete, the data is compiled into reports and reviewed for compliance.

The electronic document and records management system automates the data management, review and reporting process of TRU waste characterization data to ensure regulatory compliance for disposal at WIPP. In an exemplary embodiment, data from the characterization processes is reviewed for compliance at two levels: generation level data review and project level data review. The data cannot be certified for compliance and sent to WIPP until both levels of compliance have been met. The generation level data review is the initial review of the data from the characterization process by technical and quality personnel. Generation level data review checklists, based on the raw data, are created automatically for use by an operator. The operator collects the data, enters the data, makes measurements of the data and verifies the results in the checklist based on the raw data. Next, an independent technical reviewer is provided with an automated checklist that also contains information related to the actions of the operator. The independent technical reviewer verifies the results in the checklist based on a review of the raw data. In addition, a quality assurance officer and technical supervisor also receive automated checklists and verify the results based on a review of the raw data. Step 232 is performed to verify that the automatic generation level data review passed. If it did not pass, a non-compliance report (NCR) is created in step 234 to trigger having a corrective action performed. If the automatic generation level data review did pass at step 232, step 236 is performed to check that the automatic project level data review was passed.

The project level data review takes a look at high level requirements and can be performed by site personnel such as a site project quality assurance officer (SPQAO) and a site project manager (SPM). Generation and project level review checklists for regulatory compliance are completed automatically once the data is uploaded into the electronic system with links to raw data. The reviewer can select any link and view the raw data from the measurements to verify the checklist items. If the project level review was not passed at step 236, then step 238 is performed to initiate an NCR for performing a corrective action. Alternatively, step 240 is performed and the characterization data is uploaded to the WIPP Waste Information System (WWIS). When approval at both levels is complete, the data can be uploaded into WWIS, the DOE database for the WIPP disposal site. Step 242 is the last step of the characterization of the waste container.

FIG. 8 depicts an exemplary waste container routing form for control of waste containers, as accessed in step 206 of FIG. 2. At the top of the screen 802, an operator can select the type of characterization processes to be performed. In an exemplary embodiment the operator can choose between NDE, NDA, HSG and VE. The next section of the screen 804 includes location data and approval status. This data can include container number, container location and the status of characterization processes. The next section of the screen 806 includes waste container information. The kind of data included in an exemplary embodiment is depicted in FIG. 8. The exemplary routing form depicted in FIG. 8 also includes a container routing section 808 that allows the operator to route the container.

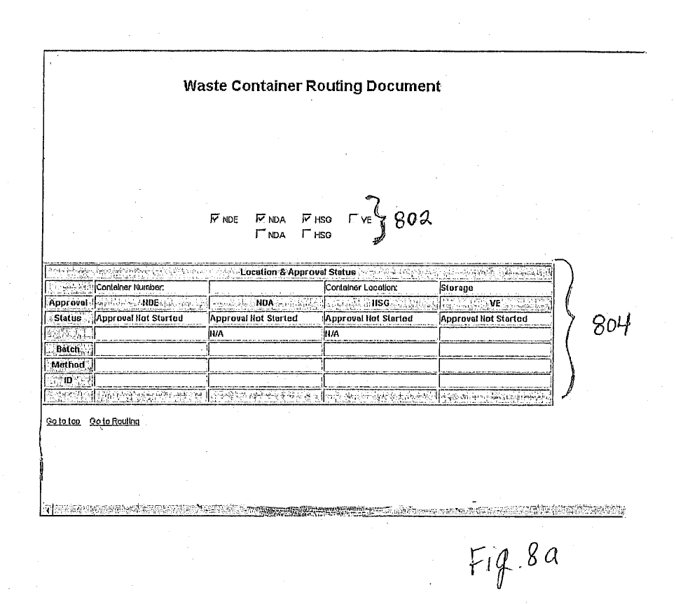

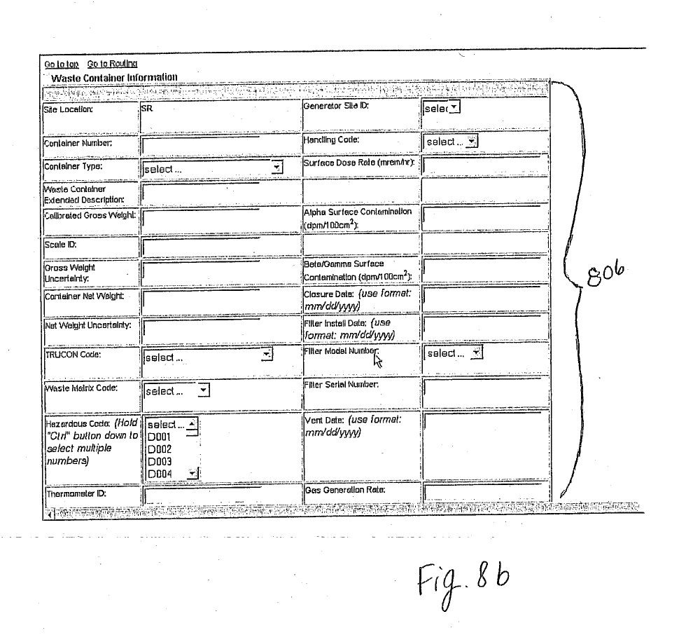

FIG. 9 depicts an exemplary generation level data review checklist with automatic links for verification as described in reference to step 232 in FIG. 2. The form contains a section 902 for the independent technical reviewer to enter data such as site number, batch number, and batch date. An exemplary embodiment also includes a checklist 904 for an independent technical reviewer.

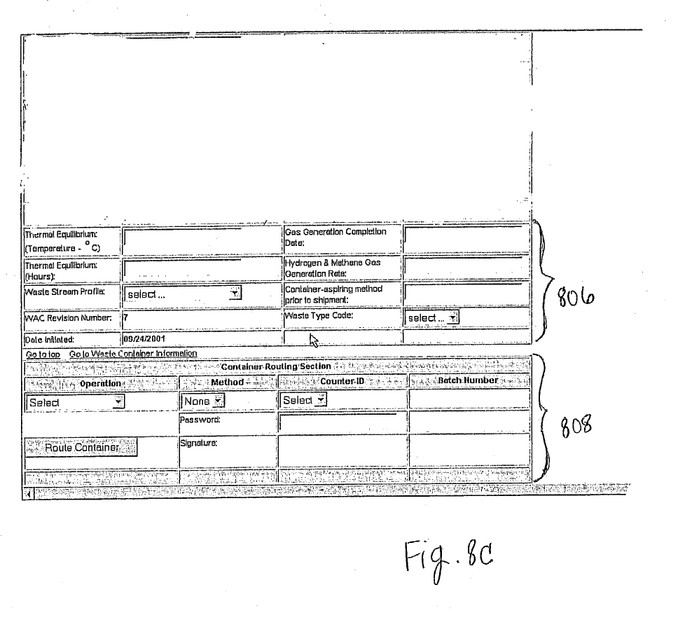

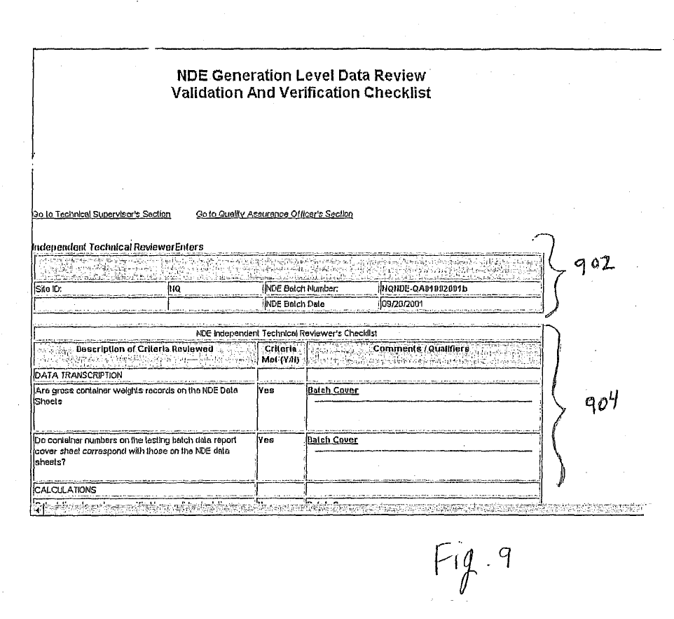

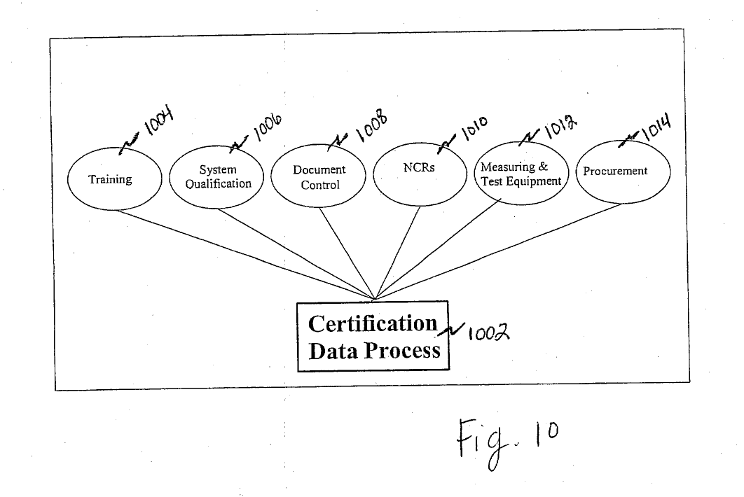

As described below and depicted in FIG. 10, an embodiment of the present invention may include linking specific criteria to a certification data process 1002. Certification is the process of collecting characterization data for the waste containers and certifying that the data meets the regulatory requirements for disposal at WIPP. An exemplary embodiment of the present invention links all criteria that can affect data quality, including training 1004, system qualification 1006, document control 1008, NCRs 1010, procurement of quality components 1014 and M&TE 1012, to the raw characterization data to verify compliance. These links are done in advance of starting the characterization process to ensure data quality up-front and not after-the-fact like the current paper-based system. The following text describes how an embodiment of the present invention links the criteria to the data in advance of making measurements.

Training records 1004 are verified automatically during the reporting process. An embodiment of the present invention includes position descriptions for all characterization personnel roles. The employee qualification summary can include the employee name, position and education level. The qualification survey can include position description, required education level, and experience requirements. The survey can also include data such as required reading and on-the-job training requirements to perform each task in the characterization process. Training records for characterization personnel are compared to the training requirements to automatically determine if an individual is qualified to perform a specific characterization function. If the individual is not qualified at the time of the measurement, the system will automatically prevent the operator from performing the work. With a paper-based system, the verification of training requirements is completed after the measurements are complete. Therefore, the electronic system ensures that only qualified personnel perform the characterization work and thereby improves data quality while minimizing rework.

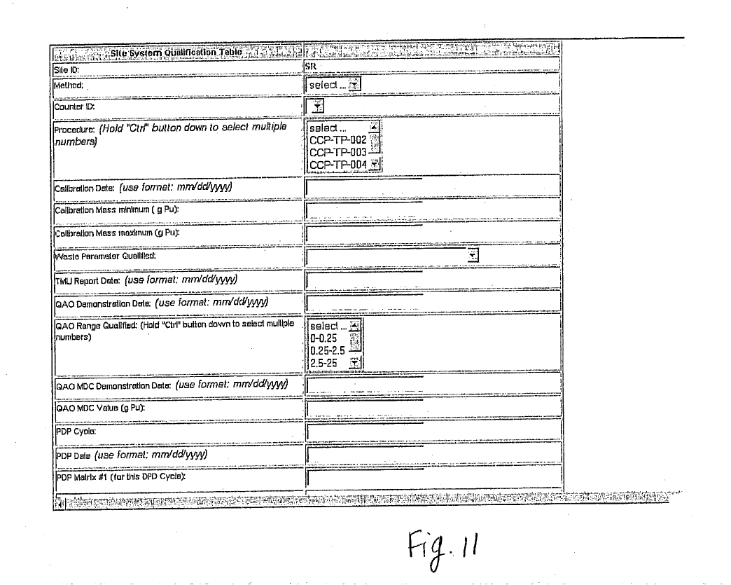

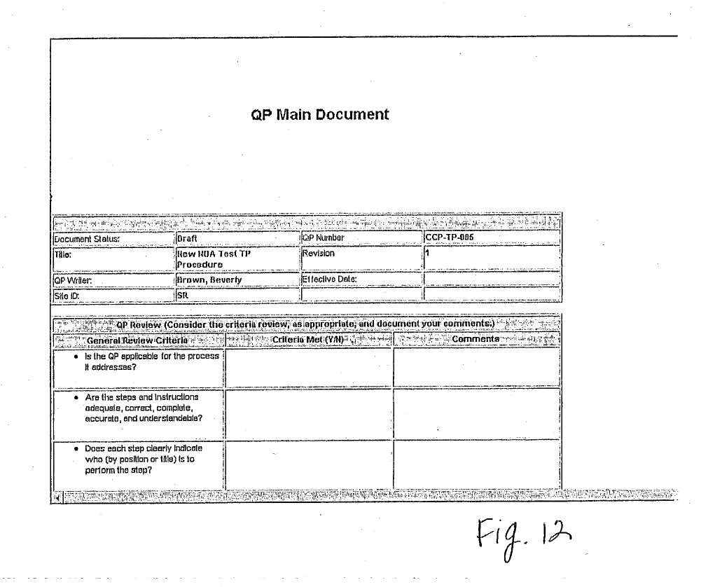

Similarly, characterization systems (e.g., NDE, NDA, VE or HSG) must be qualified by the SPM before the data can be used for TRU waste characterization. Additionally, a representative from DOE must certify the characterization system before data can be uploaded to WWIS. Qualification requirements are stored in a table such as the one depicted in FIG. 11. For example, NDA qualifications can include an approved operating procedure, valid calibration of the system, and semi-annual tests for intercomparison with other NDA systems within the DOE complex. A similar qualification form can be required for HSG and NDE systems with qualification requirements that are specific to the process. The electronic document and records management system uses the automated qualification process to ensure that only qualified systems are used for TRU waste characterization. For example, only qualified systems are displayed when an NDA operator logs on to the electronic system and tries to route a waste container for radioassay to determine the radioactive content of the waste container. In an exemplary embodiment, only NDA systems that the operator is trained on, that are qualified by the SPM, have M&TE with current calibrations, and have properly procured quality parts will be displayed. The operator will not be able to select an unqualified NDA system to collect characterization data thereby minimizing rework.

The system can automatically initiate an NCR for a waste container and prevent the upload of a non-compliant container to WWIS. For example, the NDE operator may note during a scan that the waste container contains a prohibitive item as described in the regulations. As soon as the NDE operator notes this item on the electronic form, the electronic system will automatically initiate an NCR to document that the waste container is not compliant with the regulations and cannot be shipped to WIPP for disposal until the corrective action (e.g., repackaging) is completed. The electronic system will not allow data for a non-compliant waste container be upload to WWIS, therefore, it will not be approved by WIPP for shipment. In addition to automatic NCRs for noncompliant waste containers, NCRs can be manually created by the user to document any quality concern with the characterization process.

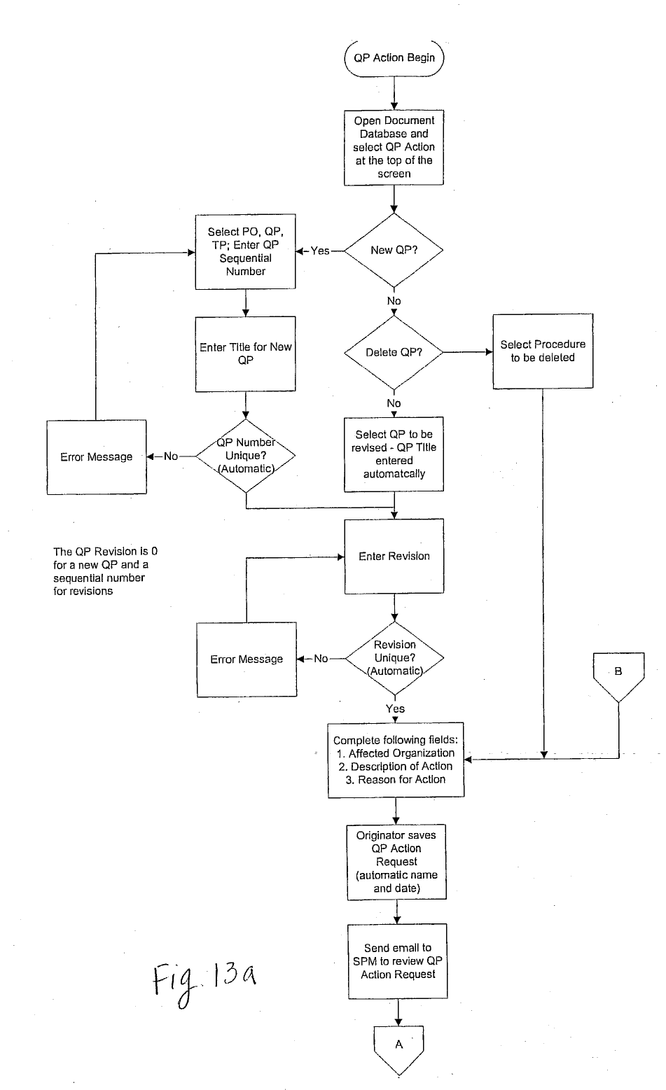

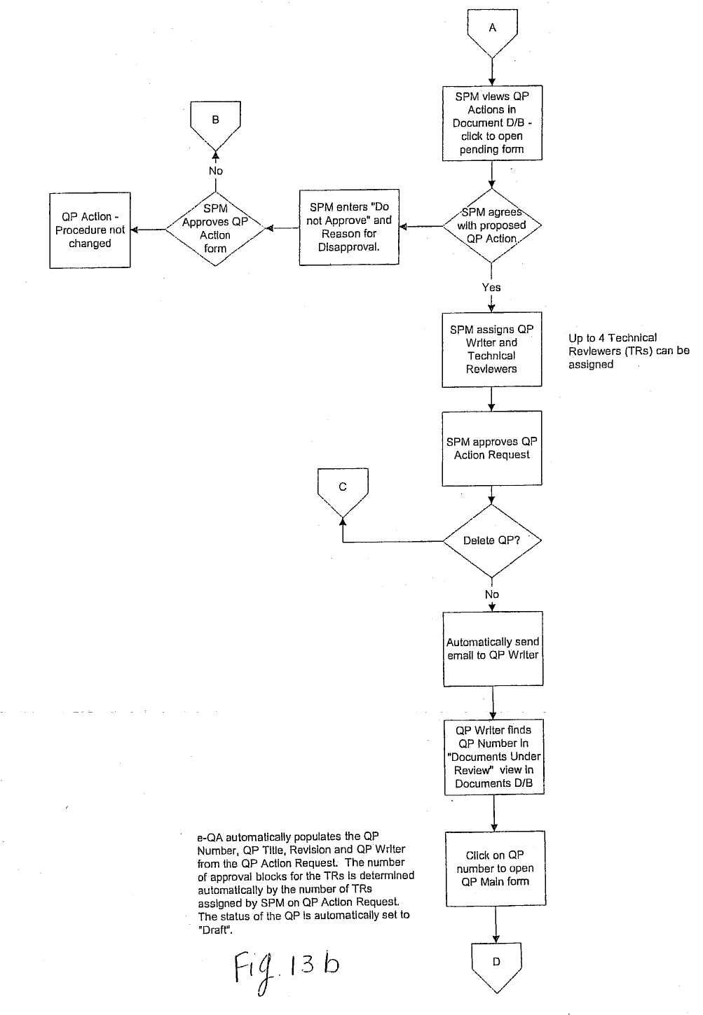

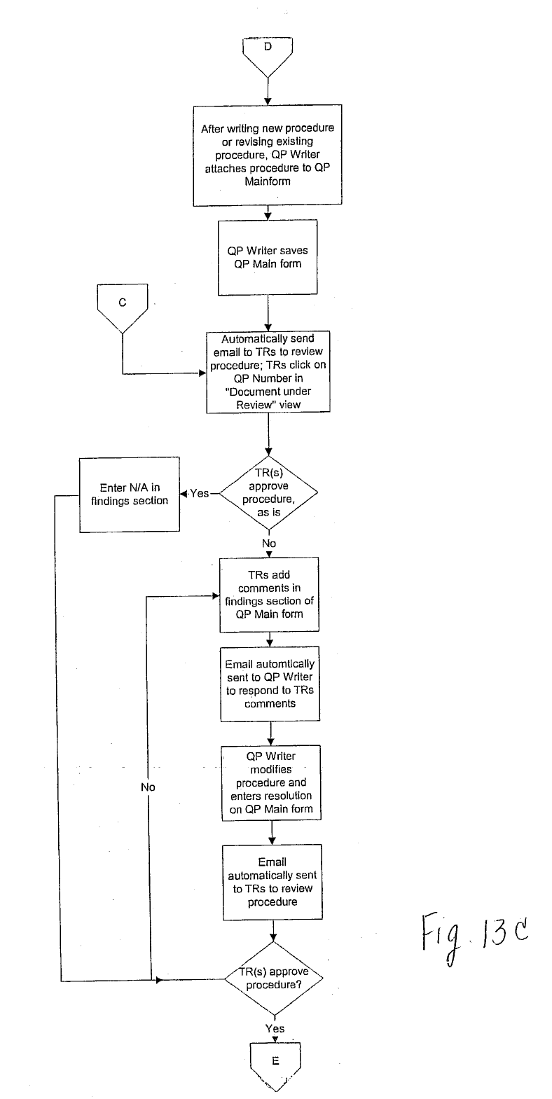

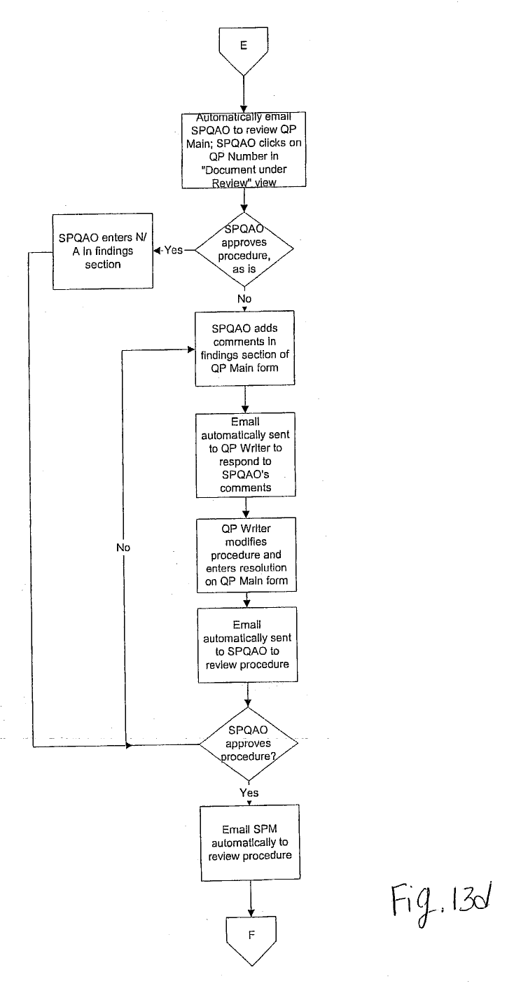

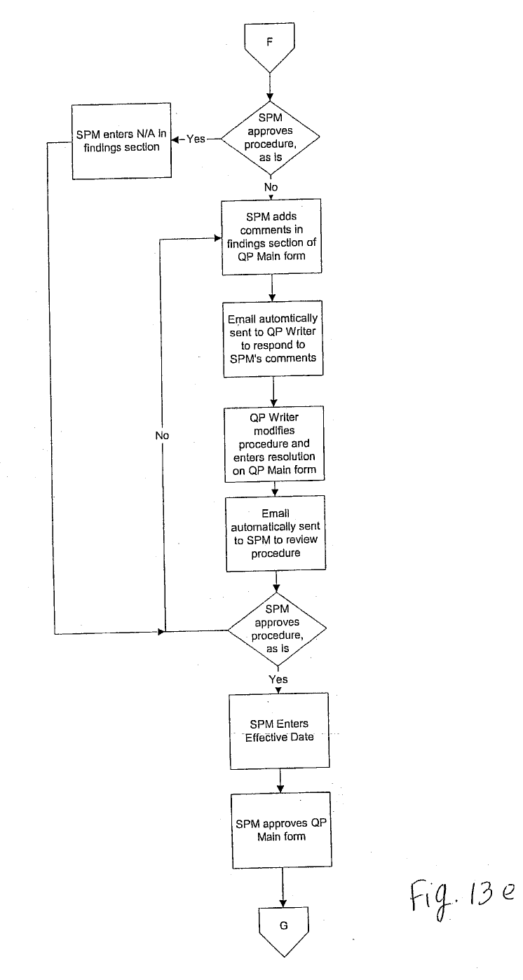

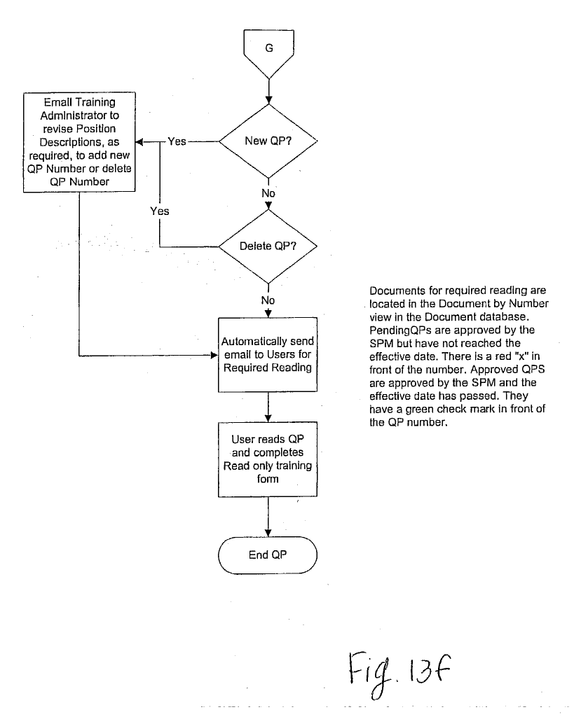

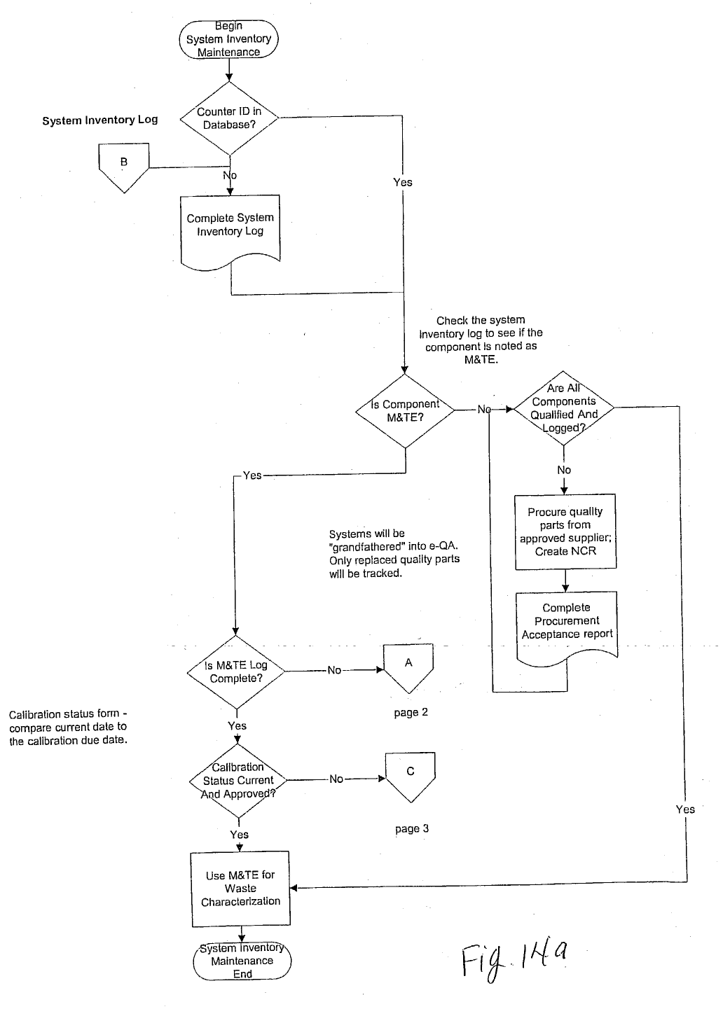

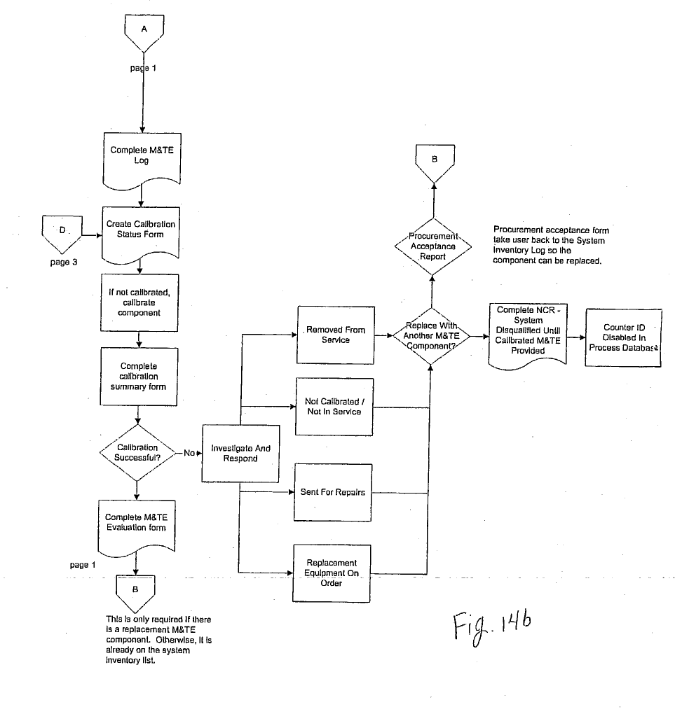

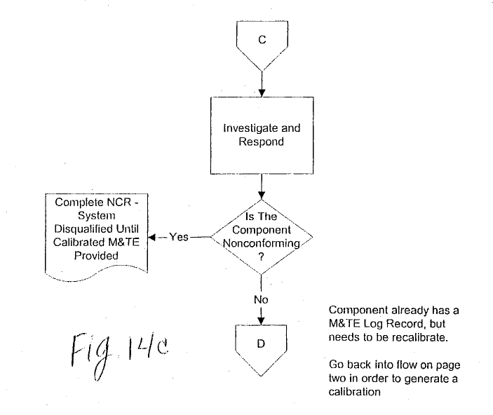

In an exemplary embodiment, a document control process using a screen such as the one depicted in FIG. 12 can be utilized to allow the creation, review, approval and revision of quality control procedures. FIG. 13 depicts a sample quality process and FIG. 14 depicts a sample administration process that can be implemented in exemplary embodiments of the present invention. These procedures are integral to a quality program for the characterization and certification process in order to ensure that users are working to current approved procedures. In an exemplary embodiment, to support the use of remote personnel for timely review and approval of quality procedures, automatic e-mail notification is used. In addition, required reading can be linked to the training records to ensure that authorized personnel are trained to the latest approved quality control procedure. If a quality procedure is revised, users that are required to train to the revised procedure will be notified by e-mail to read the procedure and to complete the required reading training form by an effective date. If the user does not complete the reading before the effective date of the revised procedure, the individual can be automatically disqualified and cannot perform the characterization task until the training requirement is completed.

Records of M&TE provide historical information on the calibration of key equipment. Current calibrations of M&TE are used to increase the quality of data by ensuring that equipment is operating properly. If M&TE calibrations are not current or out of spec, the equipment cannot be used. In an exemplary embodiment of the present invention, a system inventory log is created for each characterization system that identifies any M&TE. Once the log is approved, the M&TE log and the calibration status forms can be automatically created to track the calibration history of the M&TE. In a proactive mode, an exemplary embodiment of the present invention will not display characterization systems with out of calibration M&TE for the operator to choose from. Therefore, the M&TE calibration is verified in advance, not after-the-fact like a paper-based system.

In an exemplary embodiment of the present invention, procurement records are included in the electronic system to ensure that only quality parts (e.g., parts purchased from qualified vendors) are used on systems making characterization data. If a quality part in the characterization system is replaced, an acceptance report is entered into electronic system. Once the form is approved, the electronic system automatically updates the system inventory log to show current components. In an exemplary embodiment of the present invention, the electronic system will not display characterization systems with quality parts that are not purchased from a qualified vendor for the operator to choose from. Therefore, procurement of quality parts is verified in advance, not after-the-fact like in a paper-based system.

The present invention provides several benefits over a paper-based system. One benefit is that reporting for the HSG, NDA, NDE, and VS analysis is standardized. In addition, the reporting process has been automated by the present invention and can be used to ensure complete regulatory compliance. This reporting is performed over a secure network and is Internet based which allows access to authorized users from any location. The use of the Internet allows data from several locations to be linked in order to determine compliance. An embodiment of the present invention also ensures that only qualified personnel and equipment are used to characterize the waste. The present invention allows the testing to be done in a proactive mode in that the system verifies the personnel and equipment before it performs the characterization. This upfront verification can be done for items that include training requirements, system qualifications, M&TE calibration, and quality procurement.

As described above, the present invention can be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from other.

1. A method for electronic document and records management, the method comprising:
receiving a request from an operator for characterization of a waste container;
verifying that said operator meets a training requirement associated with said characterization;
selecting a characterization process for said waste container in response to said operator meeting said training requirement;
performing a quality process associated with said characterization process;
verifying that a characterization system associated with said characterization process meets a measurement control standard in response to completing said quality process;
initiating the performance of said characterization process on said waste container in response to said characterization system meeting said measurement control standard, wherein output from said performance includes characterization data;
verifying that said characterization data passes a generation level data review;
verifying that said characterization data passes a project level data review in response to said characterization data passing said generation level data review; and
transmitting said characterization data to a receiving system in response to said characterization data passing said project level data review.

2. The method of claim 1 wherein said waste container content includes transuranic waste.

3. The method of claim 1 further comprising providing training materials associated with said training requirement to said operator in response to said operator not meeting said training requirement.

4. The method of claim 1 wherein said characterization process includes non-destructive examination.

5. The method of claim 1 wherein said characterization process includes non-destructive assay.

6. The method of claim 1 wherein said characterization process includes headspace gas analysis.

7. The method of claim 1 wherein said characterization process includes visual inspection.

8. The method of claim 1 wherein said quality process comprises:
verifying that said characterization system has been qualified by a project manager;
initiating the performance of system qualification in response to said verifying resulting in finding that said characterization system has not been qualified by said project manager;
verifying that equipment associated with said characterization system has been calibrated;
initiating the calibrating of said equipment in response to said verifying resulting in finding that said equipment has not been calibrated;
verifying that a part associated with said characterization system is quality approved; and
attaching a certificate of compliance or an inspection report in response to said verifying resulting in finding that said part is not quality approved.

9. The method of claim 1 further comprising initiating the repair of said characterization system in response to said characterization system not meeting said measurement control standard.

10. The method of claim 1 further comprising creating a non-compliance report in response to said characterization data not passing said generation level data review.

11. The method of claim 10 further comprising initiating the performance of a corrective action responsive to said non-compliance report.

12. The method of claim 1 further comprising creating a non-compliance report in response to said characterization data not passing said project level data review.

13. The method of claim 12 further comprising initiating the performance of a corrective action responsive to said non-compliance report.

14. The method of claim 1 wherein said verifying that said characterization data passes a generation level data review includes:
generating a template checklist, wherein said generating is automated and input includes said characterization data;
updating said template checklist resulting in a generation level data review checklist in response to input from said operator; and
certifying that said characterization data passes said generation level data review in response to data contained in said generation level data review checklist.

15. The method of claim 1 wherein said verifying that said characterization data passes a generation level data review includes:
generating a template checklist, wherein said generating is automated and input includes said characterization data;
updating said template checklist resulting in a generation level data review checklist in response to input from said operator, an independent technical reviewer, a quality assurance officer and a technical supervisor; and
certifying that said characterization data passes said generation level data review in response to data contained in said generation level data review checklist.

16. The method of claim 1 wherein said verifying that said characterization data passes a project level data review includes:
generating a template checklist, wherein said generating is automated and input includes said characterization data;
updating said template checklist resulting in a project level data review checklist in response to input from said operator; and
certifying that said characterization data passes said project level data review in response to data contained in said project level data review checklist.

17. The method of claim 1 wherein said verifying that said characterization data passes a project level data review includes:
generating a template checklist, wherein said generating is automated and input includes said characterization data;
updating said template checklist resulting in a project level data review checklist in response to input from a site project quality assurance officer and a site project manager; and
certifying that said characterization data passes said project level data review in response to data contained in said project level data review checklist.

18. A system for electronic document and records management, the system comprising:
a network;
a storage device in communication with said network;
a user system in communication with said network; and
a host system in communication with said network; said host system including electronic document and records management software to implement a method comprising:
receiving a request from an operator via said user system for characterization of a waste container;
verifying that said operator meets a training requirement associated with said characterization;
selecting a characterization process for said waste container in response to said operator meeting said training requirement;
performing a quality process associated with said characterization process;
verifying that a characterization system associated with said characterization process meets a measurement control standard in response to completing said quality process;
initiating the performance of said characterization process on said waste container in response to said characterization system meeting said measurement control standard, wherein output from said performance includes characterization data;
verifying that said characterization data passes a generation level data review;
verifying that said characterization data passes a project level data review in response to said characterization data passing said generation level data review; and
transmitting said characterization data via said network to a receiving system in response to said characterization data passing said project level data review.

19. The system of claim 18 wherein said storage device includes said training materials and process steps associated with said training requirement.

20. The system of claim 18 wherein said storage device includes data and process steps associated with said quality process.

21. The system of claim 18 wherein said storage device includes data and process steps associated with said characterization process.

22. The system of claim 18 wherein said storage device includes data and process steps associated with said generation level data review.

23. The system of claim 18 wherein said storage device includes data and process steps associated with said project level data review.

24. The system of claim 18 wherein said storage device includes said characterization data.

25. The system of claim 18 wherein said storage device and said host system are located in different geographic locations.

26. The system of claim 18 wherein said storage device includes data stored in a plurality of geographic locations.

27. The system of claim 18 wherein said user system and said host system are located in different geographic locations.

28. The system of claim 18 wherein said network is an Internet.

29. The system of claim 18 wherein said network includes an Internet and a virtual private network.

30. The system of claim 18 further comprising a plurality of said user systems located at a plurality of geographic locations.

31. A computer program product for electronic document and records management, the computer program product comprising:
a storage medium readable by a processing circuit and storing instructions for execution by the processing circuit for performing a method comprising:
receiving a request from an operator for characterization of a waste container;
verifying that said operator meets a training requirement associated with said characterization;
selecting a characterization process for said waste container in response to said operator meeting said training requirement;
performing a quality process associated with said characterization process; verifying that a characterization system associated with said characterization process meets a measurement control standard in response to completing said quality process;
initiating the performance of said characterization process on said waste container in response to said characterization system meeting said measurement control standard, wherein output from said performance includes characterization data;
verifying that said characterization data passes a generation level data review;
verifying that said characterization data passes a project level data review in response to said characterization data passing said generation level data review; and
transmitting said characterization data to a receiving system in response to said characterization data passing said project level data review.
